(19) United States
(12) Patent Application Publication
(10) Pub. No.: US 2014/0131042 A1
(43) Pub. Date: May 15, 2014

(54) Methods for Generating Highly Conductive Channels in Propped Fractures

(71) Applicant: Halliburton Energy Services, Inc., (US)

(72) Inventors: Philip D. Nguyen, Houston, TX (US); Jimmie D. Weaver, Duncan, OK (US)

(73) Assignee: Halliburton Energy Services, Inc., Houston, TX (US)

(21) Appl. No.: 13/675,607

(22) Filed: Nov. 13, 2012

(51) Int. Cl. E21B 43/267; C09K 8/80

(52) U.S. Cl. CPC E21B 43/267; C09K 8/80
USPC 166/280.2; 166/280.1

(57) ABSTRACT

Methods of forming conductive channels in a subterranean formation including providing a subterranean formation having a threshold fracture gradient; introducing a fracturing fluid at a rate above the threshold fracture gradient so as to enhance or create at least one fracture in the subterranean formation; introducing a proppant slurry into the at least one fracture at a rate above the threshold fracture gradient so as to propagate the at least one fracture and deposit the proppant slurry therein; wherein the proppant slurry comprises a base fluid and proppant particulates; injecting a substantially proppant-free resilient viscous fluid into the proppant slurry deposited in the at least one fracture at a rate below the threshold fracture gradient so as to generate a continuous channel within the proppant slurry; setting the proppant slurry; and removing the substantially proppant-free resilient viscous fluid from the at least one fracture in the subterranean formation.

### BACKGROUND

The present invention relates to methods for generating highly conductive channels in propped fractures.

Subterranean wells (e.g., hydrocarbon producing wells, water producing wells, or injection wells) are often stimulated by hydraulic fracturing treatments. In traditional hydraulic fracturing treatments, a fracturing fluid, which may also function simultaneously or subsequently as a carrier fluid, is pumped into a portion of a subterranean formation at a rate and pressure sufficient to break down the formation and create one or more fractures therein. Typically, particulate solids, such as graded sand, are suspended in a portion of the fracturing fluid and then deposited into the fractures. These particulate solids, or “proppant particulates,” serve to prevent the fractures from fully closing once the hydraulic pressure is removed. By keeping the fractures from fully closing, the proppant particulates aid in forming conductive paths through which fluids produced from the formation may flow.

The degree of success of a fracturing operation depends, at least in part, upon fracture porosity and conductivity once the fracturing operation is complete and production is begun. Traditional fracturing operations place a large volume of proppant particulates into a fracture to form a “proppant pack” in order to ensure that the fracture does not close completely upon removing the hydraulic pressure. The ability of proppant particulates to maintain a fracture open depends upon the ability of the proppant particulates to withstand fracture closure and, therefore, is typically proportional to the volume of proppant particulates placed in the fracture. The porosity of a proppant pack within a fracture is related to the interconnected interstitial spaces between abutting proppant particulates. Thus, the fracture porosity is closely related to the strength of the placed proppant particulates and often tight proppant packs are unable to produce highly conductive channels within a fracture, while reducing the volume of the proppant particulates is unable to withstand fracture closures.

An additional problem that may be associated with the placement of a large volume of proppant particulates within a fracture is obstruction of the near-wellbore region of the fracture. Proppant particulates (and other formation solids such as formation fines) deep within the fracture may flow back during stimulation and/or production and cause buildup in the near-wellbore region of the fracture. The result is reduced interstitial spaces in the near-wellbore region of the fracture and a plugging of the near-wellbore region through which produced fluids must flow. Therefore, the obstruction of particulates at the near-wellbore region of the fracture may substantially reduce the conductivity potential of a fracture in a subterranean formation.

One way proposed to combat problems inherent in tight proppant packs involves placing degradable particulates within the proppant pack, which upon encountering a certain activating trigger (e.g., temperature, pH, etc.) will degrade and leave behind channels within the proppant pack. However, such degradable particulates are often unpredictable and may lead to unconnected and independent interstitial spaces within the proppant pack that fail to enhance conductivity, but rather form pockets that trap produced fluids. Additionally, the placement of the degradable particulates may not be predictably uniform throughout the proppant pack, again leaving only pockets that trap produced fluids rather than contributed to an interconnected interstitial network for fluids to flow. Moreover, degradable particulates may not be capable of thwarting plugging of the near-wellbore region of the fracture due to proppant particulate and formation fines flow back due to this unpredictability. Therefore, a method of generating highly conductive channels within a propped fracture may be of benefit to one of ordinary skill in the art.

### SUMMARY OF THE INVENTION

The present invention relates to methods for generating highly conductive channels in propped fractures.

In some embodiments, the present invention provides a method comprising: providing a subterranean formation having a threshold fracture gradient; introducing a fracturing fluid at a rate above the threshold fracture gradient so as to enhance or create at least one fracture in the subterranean formation; introducing a proppant slurry into the at least one fracture at a rate above the threshold fracture gradient so as to propagate the at least one fracture and deposit the proppant slurry therein; wherein the proppant slurry comprises a base fluid and proppant particulates; injecting a substantially proppant-free resilient viscous fluid into the proppant slurry deposited in the at least one fracture at a rate below the threshold fracture gradient so as to generate a continuous channel within the proppant slurry; setting the proppant slurry; and removing the substantially proppant-free resilient viscous fluid from the at least one fracture in the subterranean formation.

In other embodiments, the present invention provides a method comprising: providing a subterranean formation having a threshold fracture gradient; introducing a fracturing fluid at a rate above the threshold fracture gradient so as to enhance or create at least one fracture in the subterranean formation; introducing a proppant slurry into the at least one fracture at a rate above the threshold fracture gradient so as to propagate the at least one fracture and deposit the proppant slurry therein; wherein the proppant slurry comprises a base fluid and proppant particulates; injecting a substantially proppant-free resilient viscous fluid into the proppant slurry deposited in the at least one fracture at a rate below the threshold fracture gradient at spaced intervals so as to generate spaced continuous substantially proppant-free channels within the proppant slurry; setting the proppant slurry; and removing the substantially proppant-free resilient viscous fluid from the at least one fracture in the subterranean formation.

In still other embodiments, the present invention provides a method comprising: providing a subterranean formation having a threshold fracture gradient; introducing a fracturing fluid at a rate above the threshold fracture gradient so as to enhance or create at least one fracture in the subterranean formation; introducing a proppant slurry into the at least one fracture at a rate above the threshold fracture gradient so as to propagate the at least one fracture and deposit the proppant slurry therein; wherein the proppant slurry comprises a base fluid and a propping particulate; injecting a substantially proppant-free resilient viscous fluid into the proppant slurry deposited in the at least one fracture at a rate below the threshold fracture gradient so as to generate a continuous channel within the proppant slurry; wherein the substantially proppant-free resilient viscous fluid comprises a foaming agent, an encapsulated foam breaker, and a gas generating agent; setting the proppant slurry; and removing the substantially proppant-free resilient viscous fluid from the at least one fracture in the subterranean formation.

The features and advantages of the present invention will be readily apparent to those skilled in the art upon a reading of the description of the preferred embodiments that follows.

### DETAILED DESCRIPTION

The present invention relates to methods for generating highly conductive channels in propped fractures.

The present invention provides methods of creating highly conductive channels in propped fractures that are substantially proppant-free. These proppant-free highly conductive channels are characterized by longitudinal conduits substantially perpendicular to the wellbore of a subterranean formation, whether the wellbore be vertical, horizontal, or lateral, in a propped fracture. The propped fractures of the present invention may be propped using a dense proppant slurry (e.g., containing a high volume of proppant). A substantially proppant-free resilient viscous fluid is then pumped at a rate sufficient to displace the proppant slurry, such that proppant-free channels are formed. As used herein, the term “substantially proppant-free resilient viscous fluid” refers to a fluid having a viscosity in the range of about 10 centipoise (cP) to about 10,000 cP, preferably in the range of about 100 cP to about 2,000 cP, sufficient to penetrate tightly packed proppant within a propped fracture and a proppant particulate volume of no more than about 60% by weight of the substantially particulate-free resilient viscous fluid. These proppant-free channels surrounded by tightly packed proppant greatly enhances the conductivity of the propped fracture, allowing formation fluid to produce into or communicate with the wellbore freely. This is particularly true at the near-wellbore fracture, where the highly conductive channel is initiated by the injection of the substantially proppant-free resilient viscous fluid. As used herein, the term “tightly packed proppant” or “high volume of proppant” refers to a proppant pack containing no more than about 50% void space between the proppant particulates.

In one embodiment the present invention provides a method comprising providing a subterranean formation having a threshold fracture gradient, introducing a fracturing fluid at a rate above the threshold fracture gradient so as to enhance or create at least one fracture in the subterranean formation, introducing a proppant slurry into the at least one fracture at a rate above the threshold fracture gradient so as to propagate the at least one fracture and deposit the proppant slurry therein, wherein the proppant slurry comprises a base fluid and proppant particulates, injecting a substantially proppant-free resilient viscous fluid into the proppant slurry deposited in the at least one fracture at a rate below the threshold fracture gradient so as to generate a continuous foam channel within the proppant slurry, setting the proppant slurry, and removing the substantially proppant-free resilient viscous fluid from the at least one fracture in the subterranean formation. As used herein, the term “threshold fracture gradient” refers to the pressure necessary to create or enhance at least one fracture in a subterranean formation. The properties of the subterranean formation (e.g., the sediment type, the temperature, etc.) will influence the threshold fracture gradient for a particular formation.

The fracturing fluid, proppant slurry base fluid, and the substantially proppant-free resilient viscous fluid of the present invention may be any treatment fluid suitable for a fracturing or frac-packing applications as a spacer fluid, fracturing fluid, or treatment fluid, including aqueous-based fluids, oil-based fluids, water-in-oil emulsions, oil-in-water emulsions, or gelled fluids, or foamed fluids thereof. These fluids may be jointly referred to as “treatment fluids” herein. In some embodiments, the fracturing fluid, proppant slurry base fluid, and substantially proppant-free resilient viscous fluid use the same treatment fluid. In preferred embodiments, at least the treatment fluids used in the proppant slurry base fluid and the substantially proppant-free resilient viscous fluid are different such that they are substantially immiscible. One of ordinary skill in the art, with the benefit of this disclosure, will recognize the appropriate treatment fluids to use in the proppant slurry and the substantially proppant-free viscous fluid in order to ensure that the two fluids are immiscible.

Suitable aqueous-based fluids may include fresh water; saltwater (e.g., water containing one or more salts dissolved therein), brine (e.g., saturated salt water); seawater; and any combination thereof. Suitable aqueous-miscible fluids may include, but not be limited to; alcohols (e.g., methanol, ethanol, n-propanol, isopropanol, n-butanol, sec-butanol, isobutanol, and t-butanol); glycerins; glycols (e.g., polyglycols, propylene glycol, and ethylene glycol, polyglycol amines, polyols, any derivatives thereof); any in combination with a salt (e.g., sodium chloride, calcium chloride, calcium bromide, zinc bromide, potassium carbonate, sodium formate, potassium formate, cesium formate, sodium acetate, potassium acetate, calcium acetate, ammonium acetate, ammonium chloride, ammonium bromide, sodium nitrate, potassium nitrate, ammonium nitrate, ammonium sulfate, calcium nitrate, sodium carbonate, and potassium carbonate); any in combination with an aqueous-based fluid; and any combination thereof. Suitable oil-based fluids include, but are not limited to, alkanes, olefins, aromatic organic compounds, cyclic alkanes, paraffins, diesel fluids, mineral oils, desulfurized hydrogenated kerosenes, and any combinations thereof. Suitable water-in-oil emulsions, also known as invert emulsions, may have an oil-to-water ratio from a lower limit of greater than about 50:50, 55:45, 60:40, 65:35, 70:30, 75:25, or 80:20 to an upper limit of less than about 100:0, 95:5, 90:10, 85:15, 80:20, 75:25, 70:30, or 65:35 by volume, where the amount may range from any lower limit to any upper limit and encompass any subset therebetween. Examples of suitable invert emulsions include those disclosed in U.S. Pat. No. 5,905,061 entitled “Invert Emulsion Fluids Suitable for Drilling” filed on May 23, 1997, U.S. Pat. No. 5,977,031 entitled “Ester Based Invert Emulsion Drilling Fluids and Muds Having Negative Alkalinity” filed on Aug. 8, 1998, U.S. Pat. No. 6,828,279 entitled “Biodegradable Surfactant for Invert Emulsion Drilling Fluid” filed on Aug. 10, 2001, U.S. Pat. No. 7,534,745 entitled “Gelled Invert Emulsion Compositions Comprising Polyvalent Metal Salts of an Organophosphonic Acid Ester or an Organophosphinic Acid and Methods of Use and Manufacture” filed on May 5, 2004, U.S. Pat. No. 7,645,723 entitled “Method of Drilling Using Invert Emulsion Drilling Fluids” filed on Aug. 15, 2007, and U.S. Pat. No. 7,696,131 entitled “Diesel Oil-Based Invert Emulsion Drilling Fluids and Methods of Drilling Boreholes” filed on Jul. 5, 2007, each of which are incorporated herein by reference in their entirety. It should be noted that for water-in-oil and oil-in-water emulsions, any mixture of the above may be used including the water being and/or comprising an aqueous-miscible fluid.

The fracturing fluid, proppant slurry base fluid, and substantially proppant-free viscous fluid of the present invention may also be a gelled aqueous-based fluid, a gelled oil-based fluid, a gelled water-in-oil emulsion, or a gelled oil-in-water emulsion. The gelling agents suitable for use in the present invention may comprise any substance (e.g., a polymeric material) capable of increasing the viscosity of the treatment fluid. In certain embodiments, the gelling agent may comprise one or more polymers that have at least two molecules that are capable of forming a crosslink in a crosslinking reaction in the presence of a crosslinking agent, and/or polymers that have at least two molecules that are so crosslinked (i.e., a crosslinked gelling agent). The gelling agents may be naturally-occurring gelling agents; synthetic gelling agents; or a combination thereof. The gelling agents also may be cationic gelling agents; anionic gelling agents; or a combination thereof. Suitable gelling agents include, but are not limited to, polysaccharides; biopolymers; and/or derivatives thereof that contain one or more of these monosaccharide units: galactose, mannose, glucoside, glucose, xylose, arabinose, fructose, glucuronic acid, or pyranosyl sulfate. Examples of suitable polysaccharides include, but are not limited to, guar gums (e.g., hydroxyethyl guar, hydroxypropyl guar, carboxymethyl guar, carboxymethylhydroxyethyl guar, and carboxymethylhydroxypropyl guar (“CMHPG”)); cellulose derivatives (e.g., hydroxyethyl cellulose, carboxyethylcellulose, carboxymethylcellulose, and carboxymethylhydroxyethylcellulose); xanthan; scleroglucan; succinoglycan; diutan; and combinations thereof. In certain embodiments, the gelling agents comprise an organic carboxylated polymer, such as CMHPG.

Suitable synthetic polymers include, but are not limited to, 2,2′-azobis(2,4-dimethyl valeronitrile); 2,2′-azobis(2,4-dimethyl-4-methoxy valeronitrile); polymers and copolymers of acrylamide ethyltrimethyl ammonium chloride; acrylamide; acrylamido- and methacrylamido-alkyl trialkyl ammonium salts; acrylamidomethylpropane sulfonic acid; acrylamidopropyl trimethyl ammonium chloride; acrylic acid; dimethylaminoethyl methacrylamide; dimethylaminoethyl methacrylate; dimethylaminopropyl methacrylamide; dimethyldiallylammonium chloride; dimethylethyl acrylate; fumaramide; methacrylamide; methacrylamidopropyl trimethyl ammonium chloride; methacrylamidopropyldimethyl-n-dodecylammonium chloride; methacrylamidopropyldimethyl-n-octylammonium chloride; methacrylamidopropyltrimethylammonium chloride; methacryloylalkyl trialkyl ammonium salts; methacryloylethyl trimethyl ammonium chloride; methacrylylamidopropyldimethylcetylammonium chloride; N-(3-sulfopropyl)-N-methacrylamidopropyl-N,N-dimethyl ammonium betaine; N,N-dimethylacrylamide; N-methylacrylamide; nonylphenoxypoly(ethyleneoxy)ethylmethacrylate; partially hydrolyzed polyacrylamide; poly 2-amino-2-methyl propane sulfonic acid; polyvinyl alcohol; sodium 2-acrylamido-2-methylpropane sulfonate; quaternized dimethylaminoethylacrylate; quaternized dimethylaminoethylmethacrylate; any derivatives thereof; and any combinations thereof. In certain embodiments, the gelling agent comprises an acrylamide/2-(methacryloyloxy)ethyltrimethylammonium methyl sulfate copolymer. In other embodiments, the gelling agent comprises an acrylamide/2-(methacryloyloxy)ethyltrimethylammonium chloride copolymer. In still other embodiments, the gelling agent may comprise a derivatized cellulose that comprises cellulose grafted with an allyl or a vinyl monomer, such as those disclosed in U.S. Pat. Nos. 4,982,793, 5,067,565, and 5,122,549, the entire disclosures of which are incorporated herein by reference. Additionally, polymers and copolymers that comprise one or more functional groups (e.g., hydroxyl, cis-hydroxyl, carboxylic acids, derivatives of carboxylic acids, sulfate, sulfonate, phosphate, phosphonate, amino, or amide groups) may be used as gelling agents.

The gelling agent may be present in the treatment fluids of the methods of the present invention in an amount sufficient to provide the desired viscosity. In some embodiments, the gelling agents (i.e., the polymeric material) may be present in an amount in the range of from about 0.1% to about 10% by weight of the treatment fluid. In certain embodiments, the gelling agents may be present in an amount in the range of from about 0.15% to about 2.5% by weight of the treatment fluid.

In those embodiments of the present invention where it is desirable to crosslink the gelling agent, the treatment fluids may comprise one or more crosslinking agents. The crosslinking agents may comprise a borate ion, a metal ion, or a similar component that is capable of crosslinking at least two molecules of the gelling agent. Examples of suitable crosslinking agents include, but are not limited to, borate ions; magnesium ions; zirconium IV ions; titanium IV ions; aluminum ions; antimony ions; chromium ions; iron ions; copper ions; magnesium ions; and zinc ions. These ions may be provided by providing any compound that is capable of producing one or more of these ions. Examples of such compounds include, but are not limited to, ferric chloride; boric acid; disodium octaborate tetrahydrate; sodium diborate; pentaborates; ulexite; colemanite; magnesium oxide; zirconium lactate; zirconium triethanol amine; zirconium lactate triethanolamine; zirconium carbonate; zirconium acetylacetonate; zirconium malate; zirconium citrate; zirconium diisopropylamine lactate; zirconium glycolate; zirconium triethanol amine glycolate; zirconium lactate glycolate; titanium lactate; titanium malate; titanium citrate; titanium ammonium lactate; titanium triethanolamine; titanium acetylacetonate; aluminum lactate; aluminum citrate; antimony compounds; chromium compounds; iron compounds; copper compounds; zinc compounds; and any combinations thereof. In certain embodiments of the present invention, the crosslinking agent may be formulated to remain inactive until it is “activated” by, among other things, certain conditions in the fluid (e.g., pH, temperature, etc.) and/or interaction with some other substance. In some embodiments, the activation of the crosslinking agent may be delayed by encapsulation with a coating (e.g., a porous coating through which the crosslinking agent may diffuse slowly, or a degradable coating that degrades downhole) that delays the release of the crosslinking agent until a desired time or place. The choice of a particular crosslinking agent will be governed by several considerations that will be recognized by one skilled in the art, including but not limited to the following: the type of gelling agent included, the molecular weight of the gelling agent(s), the conditions in the subterranean formation being treated, the safety handling requirements, the pH of the treatment fluid, temperature, and/or the desired delay for the crosslinking agent to crosslink the gelling agent molecules.

When included, suitable crosslinking agents may be present in the treatment fluids useful in the methods of the present invention in an amount sufficient to provide the desired degree of crosslinking between molecules of the gelling agent. In certain embodiments, the crosslinking agent may be present in the first treatment fluids and/or second treatment fluids of the present invention in an amount in the range of from about 0.005% to about 1% by weight of the treatment fluid. In certain embodiments, the crosslinking agent may be present in the treatment fluids of the present invention in an amount in the range of from about 0.05% to about 1% by weight of the first treatment fluid and/or second treatment fluid. One of ordinary skill in the art, with the benefit of this disclosure, will recognize the appropriate amount of crosslinking agent to include in a treatment fluid of the present invention based on, among other things, the temperature conditions of a particular application, the type of gelling agents used, the molecular weight of the gelling agents, the desired degree of viscosification, and/or the pH of the treatment fluid.

The gelled treatment fluids useful in the methods of the present invention also may include internal gel breakers such as enzyme, oxidizing, acid buffer, or delayed gel breakers. The gel breakers may cause the treatment fluids of the present invention to revert to thin fluids that can be produced (or removed) back to the surface. In some embodiments, the gel breaker may be formulated to remain inactive until it is “activated” by, among other things, certain conditions in the fluid (e.g., pH, temperature, etc.) and/or interaction with some other substance. In some embodiments, the gel breaker may be delayed by encapsulation with a coating (e.g., a porous coatings through which the breaker may diffuse slowly, or a degradable coating that degrades inside of the wellbore) that delays the release of the gel breaker. In other embodiments, the gel breaker may be a degradable material (e.g., polylactic acid or polygylcolic acid) that releases an acid or alcohol in. In certain embodiments, the gel breaker used may be present in the treatment fluids in an amount in the range of from about 0.01% to about 10% by weight of the gelling agent. One of ordinary skill in the art, with the benefit of this disclosure, will recognize the type and amount of a gel breaker to include in certain treatment fluids of the present invention based on, among other factors, the desired amount of delay time before the gel breaks, the type of gelling agents used, the temperature conditions of the particular application, the desired rate and degree of viscosity reduction, and/or the pH of the treatment fluids.

The fracturing fluid, proppant slurry base fluid, and substantially proppant-free viscous fluid of the present invention may also be a foamed aqueous-based fluid, a foamed oil-based fluid, a foamed water-in-oil emulsion, or a foamed oil-in-water emulsion. As used herein, the term “foam” refers to a two-phase composition having a continuous liquid phase and a discontinuous gas phase. In a preferred embodiment, the substantially proppant-free viscous fluid of the present invention is a foamed treatment fluid. In those embodiments, the foamed substantially proppant-free viscous fluid of the present invention may comprise a nano-particle, a foaming agent, an encapsulated foam breaker, and/or a gas generating agent.

Nano-particles may be included in the treatment fluids in order to enhance the stability and toughness of the generated foam. In preferred embodiments, a nano-particle is included in the substantially-free resilient viscous fluid to enhance its ability to penetrate the proppant slurry within a propped fracture. Suitable nano-particles may include, but are not limited to, fumed silica; a phyllosilicate; and any combination thereof. In some embodiments, the nano-particulates are present in the treatment fluids of the present invention in the range from about 0.01% to about 10% by weight of the treatment fluid. In preferred embodiments, the nano-particulates are present in the treatment fluids of the present invention in the range from about 0.1% to about 5% by weight of the treatment fluid.

Suitable foaming agents for use in the present invention may include, but are not limited to, an ethoxylated alcohol ether sulfate; an alkyl amidopropyl betaine; an alkene amidopropyl betaine surfactant; an alkyl amidopropyl dimethyl amine oxide; and alkene amidopropyl dimethyl amine oxide; any derivatives thereof; and any combinations thereof. In some embodiments, the foaming agent is present in the treatment fluids of the present invention in an amount of about 0.01% to about 10% by volume of the treatment fluid. In preferred embodiments, the foaming agent is present in the treatment fluids of the present invention in an amount of about 0.1% to about 2% by volume of the treatment fluid.

Foam breakers function to reduce or hinder already produced foam or the future production of foam within a particular treatment fluid. Foam breakers are able to rupture air bubbles and breakdown foam. In doing so, foam breakers are able to reduce the viscosity of foamed treatment fluids in order to aid, for example, in producing (or removing) fluids back to the surface of the subterranean formation. In preferred embodiments of the present invention, the foam breaker may be encapsulated with a coating (e.g., a porous coating through which the foam breaker may diffuse slowly, or a degradable coating that degrades downhole upon an activating condition, such as, for example, pH or temperature). The coating encapsulating the foam breaker may serve to minimize interference between the foam breaking and the foaming agent such that the foaming agent is able to produce foam and the foam is broken only upon certain conditions, such as the duration or time the treatment fluid has been downhole, temperature, pH, salinity, and the like.

For use in the present invention, suitable foam breakers include any known oil-based foam breakers; water-based foam breakers; silicone-based foam breakers; polymer-based foam breakers; alkyl polyacrylate foam breakers; and any combinations thereof. Suitable oil-based foam breakers may comprise an oil carrier and a wax component. The oil carrier may include, but is not limited to, mineral oil; vegetable oil; white oil; any other oil insoluble in the treatment fluid; and any combinations thereof. The wax may include, but is not limited to, ethylene bis stearamide; paraffin wax; ester wax; fatty alcohol wax; and any combination thereof. In addition, the oil-based foam breakers of the present invention may include a hydrophobic silica. Suitable water-based foam breakers for use in the treatment fluids of the present invention may comprise a water carrier and an oil component or a water carrier and a wax component. The oil component may include, but is not limited to, white oil; vegetable oil; and any combinations thereof. The wax component may include, but is not limited to, a long chain fatty alcohol wax; a fatty acid soap wax; an ester wax; and any combinations thereof. Suitable silicone-based foam breakers may comprise a hydrophobic silicone component dispersed in a silicone oil. The silicone-based foam breaker may additionally comprise silicone glycols or other modified silicones. Suitable polymer-based foam breakers may comprise polyethylene glycol and polypropylene glycol copolymers and may be delivered in an oil carrier, a water carrier, or an emulsion base. Suitable alykyl polyacrylate foam breakers may comprise an oil carrier and an alykyl polyacrylate. In some embodiments, the foam breaker is present in the treatment fluids of the present invention in an amount in the range from about 0.01% to about 10% by volume of the treatment fluid. In preferred embodiments, the foam breaker is present in the treatment fluids of the present invention in an amount in the range from about 0.1% to about 2% by volume of the treatment fluid.

The foamed treatment fluids of the present invention may also comprise a gas generating agent. Gas generating agents may aid the foaming agent in producing a foamed treatment fluid. Some gas generating agents may be capable of forming a foamed treatment fluid without the aid of a foaming agent. Suitable gas generating agents for use in conjunction with the present invention may include, but are not limited to, nitrogen; carbon dioxide; air; methane; helium; argon; and any combination thereof. One skilled in the art, with the benefit of this disclosure, should understand the benefit of each gas. By way of nonlimiting example, carbon dioxide foams may have deeper well capability than nitrogen foams because carbon dioxide gas foams have greater density than nitrogen gas foams so that the surface pumping pressure required to reach a corresponding depth is lower with carbon dioxide than with nitrogen. In some embodiments, the quality of the foamed treatment fluid may range from a lower limit of about 5%, 10%, 25%, 40%, 50%, 60%, or 70% gas volume to an upper limit of about 95%, 90%, 80%, 75%, 60%, or 50% gas volume, and wherein the quality of the foamed treatment fluid may range from any lower limit to any upper limit and encompass any subset therebetween. Most preferably, the foamed treatment fluid may have a foam quality from about 85% to about 95%, or about 90% to about 95%.

Any of the treatment fluids of the present invention may further comprise a consolidating agent. As used herein, the term “consolidating agent” refers to a material that is capable of being coated onto a particulate and that exhibits a sticky or tacky character such that the particulates having the consolidating agent thereon have a tendency to cluster into aggregates. As used herein, the term “tacky,” in all its forms, generally refers to a substance having a nature such that it is (or may be activated to become) sticky to the touch. In some embodiments, a consolidating agent may be included in the proppant slurry in order to coat the proppant to proppant packing capabilities and aid in reducing flowback of proppant particulates and formation fines which may plug the near-wellbore fracture. In another embodiment, a consolidating agent may be included in the substantially proppant-free resilient viscous fluid in order to coat the proppant particulates within the propped fracture. As the substantially proppant-free resilient viscous fluid is injected into the proppant slurry to create a highly conductive channel, the consolidating agent adheres to the proppant particulates forming the outer diameter of the highly conductive channel. Coating the proppant particulates forming the outer diameter of the highly conductive channel may reduce or prevent proppant particulates from entering into the substantially proppant-free resilient viscous fluid or the highly conductive channel after the substantially proppant-free resilient viscous fluid is removed from the fracture.

Suitable consolidating agents may include, but are not limited to, non-aqueous tackifying agents, aqueous tackifying agents, emulsified tackifying agents, silyl-modified polyamide compounds, resins, crosslinkable aqueous polymer compositions, polymerizable organic monomer compositions, consolidating agent emulsions, zeta-potential modifying aggregating compositions, silicon-based resins, and binders. Combinations and/or derivatives of these also may be suitable. In some embodiments, a consolidating agent is present in the treatment fluids of the present invention in an amount in the range from about 0.1% to about 10% by volume of the treatment fluid. In some embodiments, a consolidating agent is present in the treatment fluids of the present invention in an amount in the range from about 0.1% to about 10% by volume of the treatment fluid.

Nonlimiting examples of suitable non-aqueous tackifying agents may be found in U.S. Pat. Nos. 7,392,847, 7,350,579, 5,853,048; 5,839,510; and 5,833,000, the entire disclosures of which are herein incorporated by reference. Nonlimiting examples of suitable aqueous tackifying agents may be found in U.S. Pat. Nos. 8,076,271, 7,131,491, 5,249,627 and 4,670,501, the entire disclosures of which are herein incorporated by reference. Nonlimiting examples of suitable crosslinkable aqueous polymer compositions may be found in U.S. Patent Application Publication Nos. 2010/0160187 (pending) and U.S. Pat. No. 8,136,595 the entire disclosures of which are herein incorporated by reference. Nonlimiting examples of suitable silyl-modified polyamide compounds may be found in U.S. Pat. No. 6,439,309 entitled the entire disclosure of which is herein incorporated by reference. Nonlimiting examples of suitable resins may be found in U.S. Pat. Nos. 7,673,686; 7,153,575; 6,677,426; 6,582,819; 6,311,773; and 4,585,064 as well as U.S. Patent Application Publication No. and 2008/0006405 (abandoned) and U.S. Pat. No. 8,261,833, the entire disclosures of which are herein incorporated by reference. Nonlimiting examples of suitable polymerizable organic monomer compositions may be found in U.S. Pat. No. 7,819,192, the entire disclosure of which is herein incorporated by reference. Nonlimiting examples of suitable consolidating agent emulsions may be found in U.S. Patent Application Publication No. 2007/0289781 (pending) the entire disclosure of which is herein incorporated by reference. Nonlimiting examples of suitable zeta-potential modifying aggregating compositions may be found in U.S. Pat. Nos. 7,956,017 and 7,392,847, the entire disclosures of which are herein incorporated by reference. Nonlimiting examples of suitable silicon-based resins may be found in Application Publication Nos. 2011/0098394 (pending), 2010/0179281 (pending), and U.S. Pat. Nos. 8,168,739 and 8,261,833, the entire disclosures of which are herein incorporated by reference. Nonlimiting examples of suitable binders may be found in U.S. Pat. Nos. 8,003,579; 7,825,074; and 6,287,639, as well as U.S. Patent Application Publication No. 2011/0039737, the entire disclosures of which are herein incorporated by reference. It is within the ability of one skilled in the art, with the benefit of this disclosure, to determine the type and amount of consolidating agent to include in the methods of the present invention to achieve the desired results.

Proppant particulates suitable for use in the proppant slurry of the present invention may be of any size and shape combination known in the art as suitable for use in a fracturing operation. Generally, where the chosen proppant is substantially spherical, suitable proppant particulates have a size in the range of from about 2 to about 400 mesh, U.S. Sieve Series. In some embodiments of the present invention, the proppant particulates have a size in the range of from about 8 to about 120 mesh, U.S. Sieve Series. A major advantage of using this method is there is no need for the solid particulates to be sieved or screened to a particular or specific particle mesh size or particular particle size distribution, but rather a wide or broad particle size distribution can be used.

In some embodiments of the present invention it may be desirable to use substantially non-spherical proppant particulates. Suitable substantially non-spherical proppant particulates may be cubic, polygonal, fibrous, or any other non-spherical shape. Such substantially non-spherical proppant particulates may be, for example, cubic-shaped, rectangular-shaped, rod-shaped, ellipse-shaped, cone-shaped, pyramid-shaped, or cylinder-shaped. That is, in embodiments wherein the proppant particulates are substantially non-spherical, the aspect ratio of the material may range such that the material is fibrous to such that it is cubic, octagonal, or any other configuration. Substantially non-spherical proppant particulates are generally sized such that the longest axis is from about 0.02 inches to about 0.3 inches in length. In other embodiments, the longest axis is from about 0.05 inches to about 0.2 inches in length. In one embodiment, the substantially non-spherical proppant particulates are cylindrical having an aspect ratio of about 1.5 to 1 and about 0.08 inches in diameter and about 0.12 inches in length. In another embodiment, the substantially non-spherical proppant particulates are cubic having sides about 0.08 inches in length. The use of substantially non-spherical proppant particulates may be desirable in some embodiments of the present invention because, among other things, they may provide a lower rate of settling when slurried into a treatment fluid. By so resisting settling, substantially non-spherical proppant particulates may provide improved proppant particulate distribution as compared to more spherical proppant particulates.

Proppant particulates suitable for use in the present invention may comprise any material suitable for use in subterranean operations. Suitable materials for these proppant particulates include, but are not limited to, a hydraulic cement; a non-hydraulic cement; a sand; a bauxite; a ceramic material; a glass material; a polymer material; a polytetrafluoroethylene material; a nut shell piece; a cured resinous particulate comprising a nut shell piece; a seed shell piece; a cured resinous particulate comprising a seed shell piece; a fruit pit piece; a cured resinous particulate comprising a fruit pit piece; a wood particulate; a silica particulate; an alumina particulate; a fumed carbon particulate; a carbon black particulate; a graphite particulate; a mica particulate; a titanium dioxide material; a meta-silicate material; a calcium silicate material; a kaolin particulate; a talc particulate; a zirconia material; a boron material; a fly ash material; any composite particulates thereof; and any combinations thereof. In preferred embodiments, hydraulic cement or non-hydraulic cement is used as the proppant particulate in the proppant slurry of the present invention.

The proppant particulates introduced into the fracture may be set by tightly packing together, by aid of the consolidating agent, by curing (e.g., cement curing), or by fracture pressure closure itself. As used herein, the term “set” or “setting” refers to substantial immobilization of at least a majority of the proppant particulates such that they do not readily freely flow out of the fracture in which they were deposited and into the wellbore.

In some embodiments of the present invention, degradable particulates are included in the proppant slurry. One purpose of including degradable particulates in a high volume proppant pack is to enhance the permeability of the proppant pack, which acts synergistically with the highly conductive channel of the present invention to maximize the flow of produced fluids in a subterranean formation. In some embodiments, the degradable particles used are oil-degradable materials, which degrade by produced fluids. In other embodiments, the degradable particulates may be degraded by materials purposely placed in the formation by injection, mixing the degradable particle with delayed reaction degradation agents, or other suitable means to induce degradation. In embodiments in which degradable particulates are used, the degradable particulates are preferably substantially uniformly distributed throughout the formed proppant pack. Over time, the degradable material will degrade, in situ, causing the degradable material to substantially be removed from the proppant pack and to leave behind voids in the proppant pack. These voids enhance the porosity of the proppant pack, which may result, in situ, in enhanced conductivity.

Suitable degradable particulates include oil-degradable polymers. Oil-degradable polymers that may be used in accordance with the present invention may be either natural or synthetic polymers. Some particular examples include, but are not limited to, polyacrylics; polyamides; and polyolefins such as polyethylene, polypropylene, polyisobutylene, and polystyrene. Other suitable oil-degradable polymers include those that have a melting point which is such that the polymer will melt or dissolve at the temperature of the subterranean formation in which it is placed, such as a wax material.

In addition to oil-degradable polymers, other degradable particulates that may be used in conjunction with the present invention include, but are not limited to, degradable polymers; dehydrated salts; and/or mixtures of the two. As for degradable polymers, a polymer is considered to be “degradable” herein if the degradation is due to, in situ, a chemical and/or radical process such as hydrolysis, or oxidation. The degradability of a polymer depends at least in part on its backbone structure. For instance, the presence of hydrolyzable and/or oxidizable linkages in the backbone often yields a material that will degrade as described herein. The rates at which such polymers degrade are dependent on, at least, the type of repetitive unit, composition, sequence, length, molecular geometry, molecular weight, morphology (e.g., crystallinity, size of spherulites, and orientation), hydrophilicity, hydrophobicity, surface area, and additives. Also, the environment to which the polymer is subjected may affect how it degrades (e.g., formation temperature, presence of moisture, oxygen, microorganisms, enzymes, pH, and the like).

Suitable examples of degradable polymers that may be used in accordance with the present invention include polysaccharides such as dextran or cellulose; chitins; chitosans; proteins; aliphatic polyesters; poly(lactides); poly(glycolides); poly(ε-caprolactones); poly(hydroxybutyrates); poly(anhydrides); aliphatic or aromatic polycarbonates; poly(orthoesters); poly(amino acids); poly(ethylene oxides); and polyphosphazenes. Of these suitable polymers, aliphatic polyesters and polyanhydrides may be preferred.

Polyanhydrides are another type of particularly suitable degradable polymer useful in the present invention. Polyanhydride hydrolysis proceeds, in situ, via free carboxylic acid chain-ends to yield carboxylic acids as final degradation products. The degradation time can be varied over a broad range by changes in the polymer backbone. Examples of suitable polyanhydrides include poly(adipic anhydride), poly(suberic anhydride), poly(sebacic anhydride), and poly(dodecanedioic anhydride). Other suitable examples include, but are not limited to, poly(maleic anhydride) and poly(benzoic anhydride).

Dehydrated salts may be used in accordance with the present invention as a degradable particulates. A dehydrated salt is suitable for use in the present invention if it will degrade over time as it hydrates. For example, a particulate solid anhydrous borate material that degrades over time may be suitable. Specific examples of particulate solid anhydrous borate materials that may be used include, but are not limited to, anhydrous sodium tetraborate (also known as anhydrous borax) and anhydrous boric acid. These anhydrous borate materials are only slightly soluble in water. However, with time and heat in a subterranean environment, the anhydrous borate materials react with the surrounding aqueous fluid and are hydrated. The resulting hydrated borate materials are highly soluble in water as compared to anhydrous borate materials and as a result degrade in the aqueous fluid. In some instances, the total time required for the anhydrous borate materials to degrade in an aqueous fluid is in the range of from about 8 hours to about 72 hours depending upon the temperature of the subterranean zone in which they are placed. Other examples include organic or inorganic salts like acetate trihydrate.

Blends of certain degradable materials may also be suitable as degradable particulates. One example of a suitable blend of materials is a mixture of poly(lactic acid) and sodium borate where the mixing of an acid and base could result in a neutral solution where this is desirable. Another example would include a blend of poly(lactic acid) and boric oxide. Other materials that undergo an irreversible degradation may also be suitable, if the products of the degradation do not undesirably interfere with either the conductivity of the proppant matrix or with the production of any of the fluids from the subterranean formation.

In some embodiments of the present invention, the degradable particulates are present in the range from about 10% to about 90% by weight of the combined total of proppant particulates and degradable particulates. In other embodiments, the degradable particulates are present in the range from about 20% to about 70% by weight of the combined total of proppant particulates and degradable particulates. In still other embodiments, the degradable particulars are present in the range from about 25% to about 50% by weight of the combined total of proppant particulates and degradable particulates. One of ordinary skill in the art with the benefit of this disclosure will recognize an optimum concentration of degradable particulates that provides desirable values in terms of enhanced conductivity or permeability without undermining the stability of the high porosity fracture itself.

In some embodiments, the present invention provides for a method of providing a subterranean formation having a threshold fracture gradient introducing a fracturing fluid at a rate above the threshold fracture gradient so as to enhance or create at least one fracture in the subterranean formation, introducing a proppant slurry into the at least one fracture at a rate above the threshold fracture gradient so as to propagate the at least one fracture and deposit the proppant slurry therein, wherein the proppant slurry comprises a base fluid and proppant particulates, injecting a substantially proppant-free resilient viscous fluid into the proppant slurry deposited in the at least one fracture at a rate below the threshold fracture gradient at spaced intervals so as to generate spaced continuous substantially proppant-free channels within the proppant slurry, setting the proppant slurry and removing the substantially proppant-free resilient viscous fluid from the at least one fracture in the subterranean formation. Large fractures may be tightly packed with proppant particulates and/or proppant particulates and degradable particulates. Using an inflatable straddle packer or an opposing washcup packer, the substantially proppant-free viscous fluid can be injected through the proppant slurry at multiple intervals within a single fracture, thereby creating multiple highly conductive channels within a single fracture. By creating multiple highly conductive channels using the present invention in a single fracture, the conductivity of the fracture may be enhanced because the produced fluids have more conduits through which to travel to the near-wellbore fracture. In those embodiments in which the substantially proppant-free viscous fluid is injected at spaced intervals within a fracture, it is preferred that the spacing is no more than 10 feet apart, and preferably no more than 5 feet apart.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

The invention claimed is:

1. A method comprising:
providing a subterranean formation having a threshold fracture gradient;
introducing a fracturing fluid at a rate above the threshold fracture gradient so as to enhance or create at least one fracture in the subterranean formation;
introducing a proppant slurry into the at least one fracture at a rate above the threshold fracture gradient so as to propagate the at least one fracture and deposit the proppant slurry therein;
wherein the proppant slurry comprises a base fluid and proppant particulates;
injecting a substantially proppant-free resilient viscous fluid into the proppant slurry deposited in the at least one fracture at a rate below the threshold fracture gradient so as to generate a continuous channel within the proppant slurry;
setting the proppant particulates; and
removing the substantially proppant-free resilient viscous fluid from the at least one fracture in the subterranean formation.

2. The method of claim 1, wherein the propping particulate is a hydraulic cement; a non-hydraulic cement; a sand; a bauxite; a ceramic material; a glass material; a polymer material; a polytetrafluoroethylene material; a nut shell piece; a cured resinous particulate comprising a nut shell piece; a seed shell piece; a cured resinous particulate comprising a seed shell piece; a fruit pit piece; a cured resinous particulate comprising a fruit pit piece; a wood particulate; a silica particulate; an alumina particulate; a fumed carbon particulate; a carbon black particulate; a graphite particulate; a mica particulate; a titanium dioxide material; a meta-silicate material; a calcium silicate material; a kaolin particulate; a talc particulate; a zirconia material; a boron material; a fly ash material; any composite particulates thereof; and any combinations thereof.

3. The method of claim 1, wherein the proppant slurry further comprises a consolidating agent.

4. The method of claim 1, wherein the proppant slurry further comprises a degradable particulate.

5. The method of claim 1, wherein the substantially proppant-free resilient viscous fluid comprises a foaming agent and an encapsulated foam breaker.

6. The method of claim 5, wherein the foaming agent is selected from the group consisting of an ethoxylated alcohol ether sulfate; an alkyl amidopropyl betaine; an alkene amidopropyl betaine surfactant; an alkyl amidopropyl dimethyl amine oxide; and alkene amidopropyl dimethyl amine oxide; any derivatives thereof; and any combinations thereof.

7. The method of claim 5, wherein the foam breaker is selected from the group consisting of an oil-based foam breakers; water-based foam breakers; silicone-based foam breakers; polymer-based foam breakers; alkyl polyacrylate foam breakers; and any combinations thereof.

8. The method of claim 5, wherein the resilient foam further comprises a gas generating agent selected from the group consisting of nitrogen; carbon dioxide; air; methane; helium; argon; and any combination thereof.

9. The method of claim 5, wherein the substantially proppant-free resilient viscous fluid further comprises a nano-particle.

10. The method of claim 5, wherein the substantially proppant-free resilient viscous fluid further comprises a consolidating agent.

11. The method of claim 1, wherein the substantially proppant-free resilient viscous fluid is injected at spaced intervals in the fracture, wherein the spaced intervals are spaced at no greater than about 5 feet apart.

12. A method comprising:
providing a subterranean formation having a threshold fracture gradient;
introducing a fracturing fluid at a rate above the threshold fracture gradient so as to enhance or create at least one fracture in the subterranean formation;
introducing a proppant slurry into the at least one fracture at a rate above the threshold fracture gradient so as to propagate the at least one fracture and deposit the proppant slurry therein;
wherein the proppant slurry comprises a base fluid and proppant particulates;
injecting a substantially proppant-free resilient viscous fluid into the proppant slurry deposited in the at least one fracture at a rate below the threshold fracture gradient at spaced intervals so as to generate spaced continuous substantially proppant-free channels within the proppant slurry;
setting the proppant particulates; and
removing the substantially proppant-free resilient viscous fluid from the at least one fracture in the subterranean formation.

13. The method of claim 12, wherein the substantially proppant-free resilient viscous fluid is injected at spaced intervals using an inflatable straddle packer or an opposing washcup packer.

14. The method of claim 12, wherein the substantially proppant-free resilient viscous fluid is injected at spaced intervals in the fracture, wherein the spaced intervals are spaced at no greater than about 5 feet apart.

15. The method of claim 12, wherein the substantially proppant-free resilient viscous fluid comprises a foaming agent, an encapsulated foam breaker, a gas generating agent, and a nano-particle.

16. A method comprising:
providing a subterranean formation having a threshold fracture gradient;
introducing a fracturing fluid at a rate above the threshold fracture gradient so as to enhance or create at least one fracture in the subterranean formation;
introducing a proppant slurry into the at least one fracture at a rate above the threshold fracture gradient so as to propagate the at least one fracture and deposit the proppant slurry therein;
wherein the proppant slurry comprises a base fluid and a propping particulate;
injecting a substantially proppant-free resilient viscous fluid into the proppant slurry deposited in the at least one fracture at a rate below the threshold fracture gradient so as to generate a continuous channel within the proppant slurry;
wherein the substantially proppant-free resilient viscous fluid comprises a foaming agent, an encapsulated foam breaker, and a gas generating agent;
setting the proppant particulates; and
removing the substantially proppant-free resilient viscous fluid from the at least one fracture in the subterranean formation.

17. The method of claim 16, wherein the substantially proppant-free resilient viscous fluid is injected at spaced intervals in the fracture, wherein the spaced intervals are spaced at no greater than about 5 feet apart.

18. The method of claim 16, wherein the foaming agent is present in an amount of about 0.1% to about 10% by volume of the substantially proppant-free resilient viscous fluid.

19. The method of claim 16, wherein the base fluid of the proppant slurry and the substantially proppant-free resilient viscous fluid are immiscible.

20. The method of claim 16, wherein the substantially proppant-free resilient viscous fluid further comprises a consolidating agent.
